(19) United States
(12) Patent Application Publication
(10) Pub. No.: US 2025/0198440 A1
(43) Pub. Date: Jun. 19, 2025

(54) MECHANISM FOR JOINING STUDS

(71) Applicant: PETRÒLEO BRASILEIRO S. A.- PETROBRAS, Rio de Janeiro (BR)

(72) Inventors: VINICIUS SANTOS LIMA, Betim (BR); WAGNER HENRIQUE SALDANHA, Betim (BR); THIAGO RAFAEL DE OLIVEIRA, Betim (BR); ELBERT FERNANDO MARTINS COELHO, Betim (BR)

(73) Assignee: PETRÔLEO BRASILEIRO S. A. -PETROBRAS, Rio de Janeiro (BR)

(21) Appl. No.: 18/985,825

(22) Filed: Dec. 18, 2024

(30) Foreign Application Priority Data
Dec. 19, 2023 (BR) 2020230268167

(51) Int. Cl. F16B 7/18

(52) U.S. Cl. CPC F16B 7/18

(57) ABSTRACT

The present application falls within the field of devices for joining structural elements or machine parts; more specifically, in the maintenance for equipment studs, such as heat exchangers, such that there are limitations. For example, the body of the equipment itself, or by any obstacle close to the connection (usually another piece of equipment), makes it not possible to remove all the studs from the connection without interrupting the operation to disassemble components. In this way, the present application comprises a joining mechanism for connecting a two-part stud. The first part of the two-part stud being on an opposite side to the second part of the two-part stud. The joining mechanism connects the first part of the two-part stud to the second part of the two-part stud in a symmetrical manner.

### CROSS-REFERENCE TO RELATED APPLICATION

This application claims priority to Brazilian Application No. BR 2020230268167, filed on Dec. 19, 2023, the disclosure of which is incorporated by reference herein in its entirety.

### FIELD

This present application falls within the field of devices for joining structural elements or machine parts. More specifically, the present application is related to maintenance for equipment studs.

### BACKGROUND

One of the most commonly adopted processes for joining mechanical parts is the flanged connection, in which studs/bolts are used to join two surfaces, in order to seal the joint.

In this way, when a flanged connection presents a leak, it is necessary to retighten the studs, as a way of maintaining the equipment without having to interrupt its operation. However, this strategy is only effective when combined with lubrication of the thread fillets of the old studs, since the nut “locks” the movement due to the corrosion/oxidation of the old studs, so that it is not possible to tension the old stud, or to replace it with a new stud, because the new stud has a lower coefficient of friction than the old stud.

However, in some cases where the stud is relatively long and the space is limited by the body of the equipment itself, or by any obstacle close to the connection, it is not possible to remove the old stud without interrupting the operation to disassemble the components, such as, for example, studs for closing the lid of a shell/tube heat exchanger. In this case, the number of studs positioned in the location is considerable, making it necessary to disassemble the lid.

In this way, it is in these situations that this present application falls within, facilitating the exchange of old studs in hard-to-reach places, without the need to disassemble the equipment to perform this work, thus ensuring better productivity and savings, since the equipment does not need to have its operation interrupted to exchange said old studs.

### STATE OF THE ART

The State of the Art discloses a technology that fits the same objective as the present application, in which, however, unresolved deficiencies still persist.

Document CN115929758A discloses a screw with a divided combined structure and a method of combining the same, referring to the technical field of screws, and aims at solving the problems that the head and screw of a conventional screw are mostly of integrated structure. The screw is formed integrally, and one end of the screw is first connected to a fixed thread groove and connected externally, so that a part of the threads is first damaged by friction and the screw cannot be assembled. After the screw is damaged, it is replaced with a new one, so the waste is serious, and the existing screw is easily detached and stolen by an external tool, so the anti-theft performance is poor.

According to CN115929758A, a second cylindrical rod is arranged above the first cylindrical rod, a connecting base is arranged at the upper end of the second cylindrical rod, a limiting disc is arranged at the upper end of the connecting base, the limiting disc and the connecting base are of an integrated structure; an outwardly protruding fixing base is arranged at the upper end of the limiting disc, and the outwardly protruding fixing base and the limiting disc are of an integrated structure; the mounting groove is formed on the upper surface of the limiting disc, and the mounting groove and the limiting disc are of an integrated structure.

The present application differs from the invention in document CN115929758A, since the present application presents threads along all sections of the stud, while the presented document does not disclose threads in a region where the studs are joined. In addition, the stud described in said document has an internal thread and an external thread, while the present application describes only an external thread to the stud, which, considering the same root area, guarantees a smaller diameter.

### SUMMARY

The present application comprises a joining mechanism for connecting a two-part stud, providing for the replacement of damaged studs in flanged connections that are arranged in environments with limited space and difficult to remove.

Thus, the present application comprises a joining mechanism for a two-part stud, with a first part of the two-part stud and a second part of the two-part stud; the first part of the two-part stud being on an opposite side to the second part of the two-part stud, and wherein the joining mechanism connects the first part of the two-part stud to the second part of the two-part stud in a symmetrical manner.

### BRIEF DESCRIPTION OF THE DRAWINGS

The present invention will be described below with reference to its typical embodiments and with reference to the attached drawings, in which:

FIG. 1 shows the joining mechanism that connects a first part of the two-part stud and a second part of the two-part stud.

FIG. 2 shows a stud as it is used.

FIG. 3 shows a two-part stud being formed by a first part of a two-part stud and a second part of a two-part stud.

FIG. 4 shows a first part of a two-part stud connected to a joining mechanism.

FIG. 5 shows a second part of a two-part stud connected to a joining mechanism and a first part of a two-part stud.

FIG. 6 shows the results of a tensile test performed on the test specimens.

### DETAILED DESCRIPTION

Specific embodiments of the present disclosure are described below. In an effort to provide a concise description of these embodiments, all features of an actual implementation may not be described in the specification. It should be appreciated that in the development of any actual implementation, as in any engineering or design project, numerous implementation-specific decisions must be made to achieve the specific objectives of the developers, such as compliance with system-related and business constraints, which may vary from one implementation to another. In addition, it should be appreciated that such a development effort may be complex and time-consuming, but would nevertheless be a routine design and manufacturing undertaking for those of ordinary skill having the benefit of this disclosure.

Accordingly, certain details may be omitted from the description that follows with the understanding that the technician skilled on the subject has prior knowledge to fill these gaps. For example, the specific types of used devices or underlying physical principles may be omitted without impairing the description of the present invention.

The present application falls within the field of devices for joining structural elements or machine parts; more specifically in the maintenance means for such as equipment studs, heat exchangers, wherein limitations are found, for example, by the body of the equipment itself, or by any obstacle near the connection (usually another piece of equipment), so that it is not possible to remove all the studs from the connection without interrupting the operation to disassemble components.

In this the way, present application facilitates the replacement of old studs in hard-to-reach places without the need to disassemble the equipment to perform this activity. This ensures better productivity and savings, since the equipment does not need to be interrupted to replace said old studs.

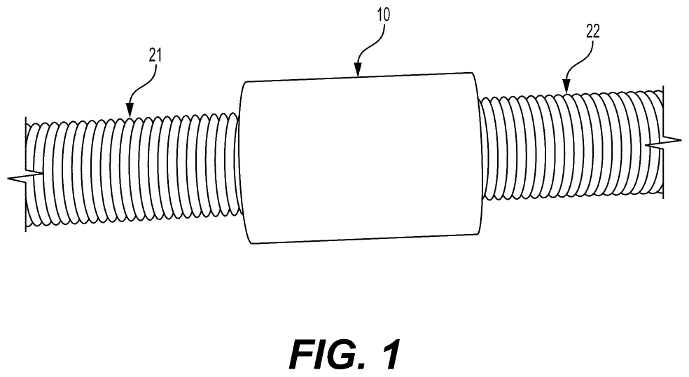

To achieve this feat, the present application comprises a joining mechanism 10 and a two-part stud 20, wherein the two-part stud 20 is divided into the first part of the two-part stud 21 and the second part of the stud 22, as illustrated in FIG. 1. The two-part stud 20 may be a worm thread, a screw or a threaded rod, as long as it meets the design code of the equipment in which the Utility Model will be installed.

The two-part stud 20, when divided into the first part of the two-part stud 21 and the second part of the two-part stud 22, has its length reduced, allowing assembly and disassembly in places with limited space.

The joining mechanism 10 preferably has a cylindrical shape and an internal thread, capable of making a threaded connection with the stud 20. The length of the joining mechanism 10 must be at least twice the diameter of the stud 20, so that the thread is equivalent to two nuts used in a flanged connection stud.

If the length of the joining mechanism 10 is minimal, that is, equivalent to twice the diameter of the stud 20, the mechanism must be assembled symmetrically. In this way, half of the threads must be threaded into the first part of the two-part stud 21 and the other half of the threads into the second part of the two-part stud 22.

If the length of the joining mechanism 10 is greater than twice the diameter of the stud 20, this symmetry can be discarded; however, each part of the stud 21 and 22 must be threaded with at least the same number of thread fillets existing in the compatible nut.

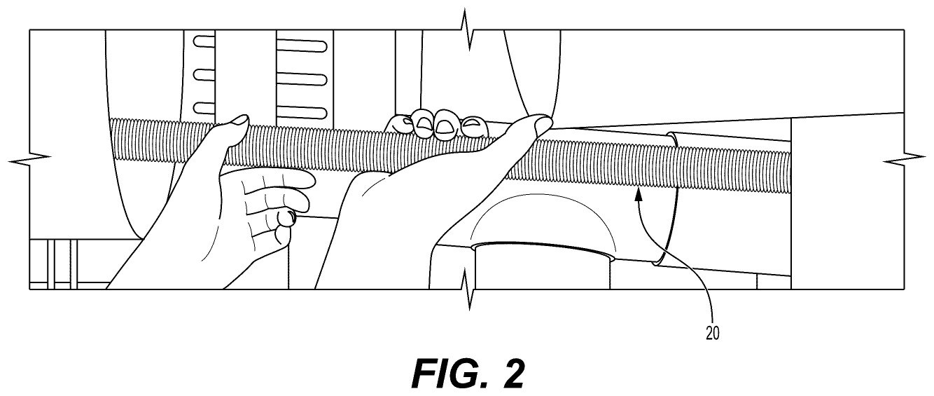

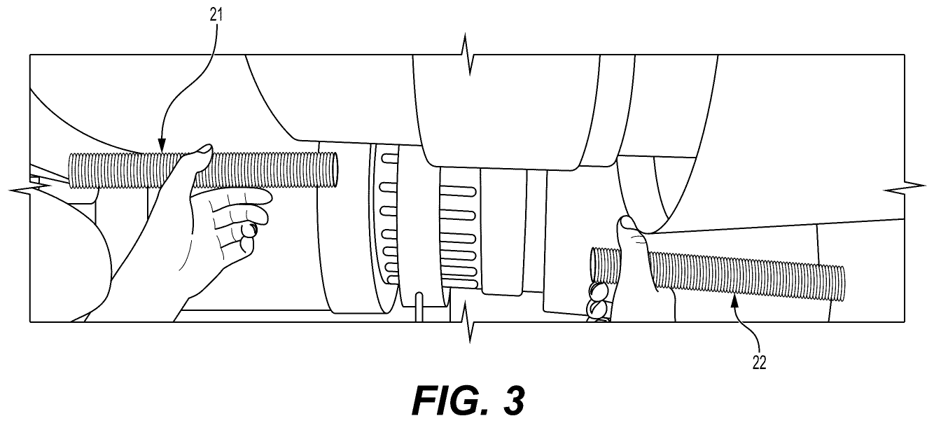

In FIG. 2, it is possible to see the two-part stud 20 being installed in its entirety in the flange positioning; however, it is observed that it is not possible to fit the stud 20 in its entirety. Thus, the stud 20 is divided into the first part of the two-part stud 21 and the second part of the two-part stud 22, as seen in FIG. 3.

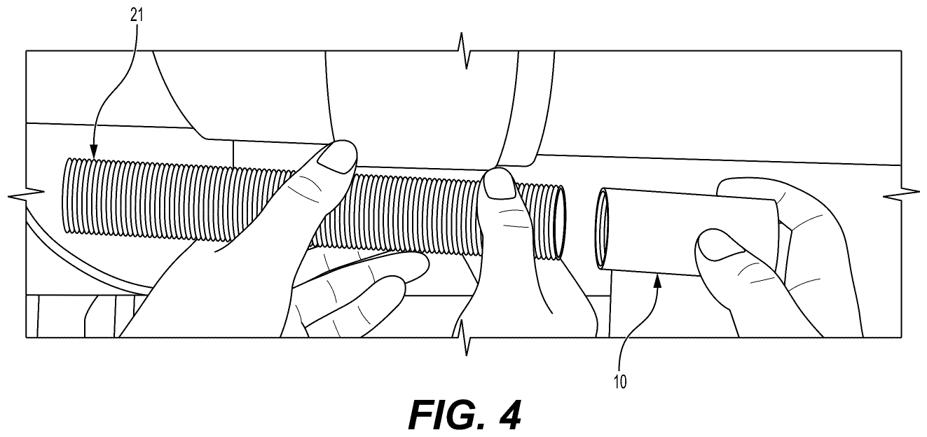

To assemble the joining mechanism 10, it is first necessary to remove the damaged stud 20 from the structure. After removing the damaged stud 20, a first part of the two-part stud 21 is inserted into the flange and is connected to the joining mechanism 10 by means of a thread, as can be seen in FIG. 4.

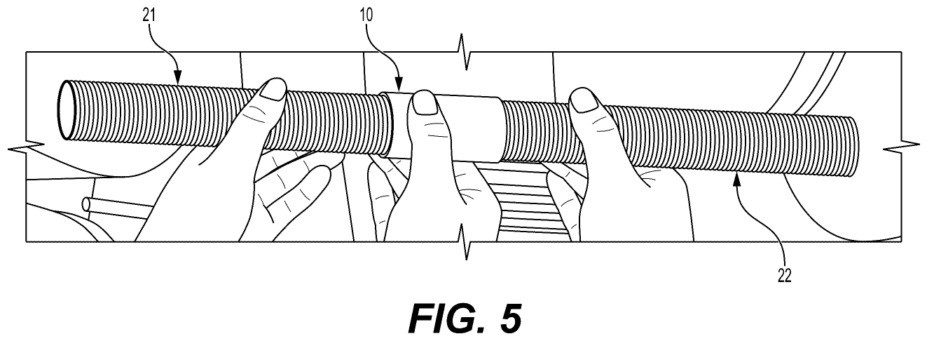

Next, a second part of the two-part stud 22 is inserted on the opposite side to the first part of the two-part stud 21 that is connected to the joining mechanism 10. As seen in FIG. 5, the joining mechanism 10 is connected to the second part of the two-part stud 22 by means of a thread, being joined to the first part of the two-part stud 21.

In this way, when screwing the joining mechanism 10 to the second part of the two-part stud 22, joining it to the first part of the two-part stud 21, this makes the two-part stud 20 a linear and unique structure, as can be seen in FIG. 5.

The joining mechanism 10 described in the present application can be applied throughout the industrial sector, in any flange connections in which the space between the flanges is at least twice the diameter of the stud or larger, and the space around the stud is of a free diameter (Dm) concentric with the diameter of the stud (Db), such that:

$${D}_{m} = {D}_{b \cdot } \sqrt{2} \qquad Equation 1$$

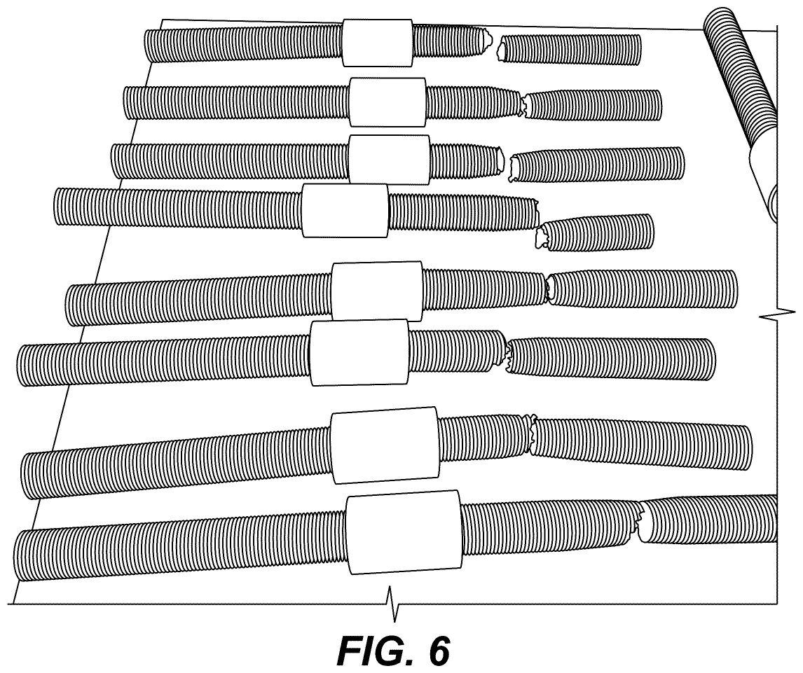

According to the performed tensile tests, in the parts dimensioned with root area (area of the cross-section of the wall of the joining mechanism 10 subtracting the height of the thread fillets, equivalent to the area of the entire stud 20), a rupture occurs in the stud 20 in all tests, and the integrity of the joining mechanism 10 is maintained, as can be seen in FIG. 6.

This is due to the control of the dimensions of the thread of the joining mechanism 10, resulting from the control of the radius of the largest diameter of the internal thread of the mechanism. The idea is to minimize the concentration of stresses in the flanks of the joint thread, thus providing greater resistance in the thread of the mechanism 10. In addition, the joining mechanism 10 also undergoes heat treatment, ensuring greater strength.

The two-part studs must have the same specifications as the equipment design studs. For example, in a piece of equipment that operates with ASTM A-193 B7 studs, the two-part bars must have the same specifications.

1. A mechanism for joining studs, the mechanism comprising:
a two-part stud comprising:
a first part of the two-part stud; and
a second part of the two-part stud disposed on a side opposite to the first part of the two-part stud;
wherein the joining mechanism is connected to the first part of the two-part stud by threads,
wherein the second part of the two-part stud is connected to the joining mechanism by threads;
wherein the joining mechanism is used when:
the length of the joining mechanism is at least twice the diameter of the stud, and
the free diameter (Dm), around the stud,
concentric with the diameter of the stud (Db), is given by Dₘ=D_{b}·\sqrt{2}.
